(19) United States
(12) Patent Application Publication
(10) Pub. No.: US 2004/0150243 A1
(43) Pub. Date: Aug. 5, 2004

(54) Automobile vehicle rear seat layout including a folding backrest equipped with a headrest and vehicle including such a seat

(75) Inventors: David Epaud, Morsang Sur Orge (FR); Francois Fourrey, Corquilleroy (FR); Fabrice Lesbats, Sucy En Brie (FR)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: FAURECIA SIEGES D'AUTOMOBILE S.A., NANTERRE (FR)

(21) Appl. No.: 10/703,402

(22) Filed: Nov. 7, 2003

(30) Foreign Application Priority Data
Nov. 7, 2002 (FR) 02 13911

(51) Int. Cl. B60N 2/10

(52) U.S. Cl. 296/65.09

(57) ABSTRACT

The automobile vehicle rear seat layout includes a backrest (21) which can be raised and tilted forwards, a backrest (24) which can be folded down onto the location normally occupied by the seat pan, the backrest being equipped with a headrest (26), the seat pan and the backrest being installed so as to pivot on the floor (3) of the vehicle. To allow the backrest to be folded down by a maximum without removing the headrests, the thickness of the seat pan is reduced at least in the part (5) located opposite the headrest when the backrest is folded down and, in the zone of the floor located opposite the part of the seat pan where the thickness is reduced when the seat pan is in normal utilization condition, an additional padding element (4) is attached to the floor to compensate for the reduction in the thickness of the seat pan.

### CROSS-REFERENCE TO RELATED APPLICATIONS

This application is based upon and claims priority from French Patent Application No. 02-13911, filed Nov. 7, 2002, the entire disclosure of which is herein incorporated by reference.

### BACKGROUND OF THE INVENTION

1. Field of the Invention

The present invention concerns an automobile vehicle rear seat layout and, more especially, a seat of the type including a seat pan which tilts forwards and a folding backrest equipped with a headrest.

2. Description of Related Art

Such seats are well known and, with the aim of temporarily increasing the load-carrying space in the boot, they generally include a seat pan which can be raised and tilted forwards to be placed against the backrest of the front seat and a backrest which can be folded forwards and down onto the floor of the vehicle at the location normally occupied by the seat pan. However, when the rear seats are equipped with headrests, the size of the headrests may hinder the folding down of the backrest as the headrest comes into contact with the bottom of the seat pan which is in a more or less vertical position after having been tilted.

In certain cases, the heights of the headrests can be adjusted and the headrests can to a great extent be retracted into the backrest when they are lowered by a maximum, the overall size of the backrest then being only slightly increased, which can sometimes be sufficient to allow the backrest to be completely folded down. However, this is not always sufficient and it is therefore often necessary to remove the headrests from the rear seat before tilting the backrest forwards which requires an additional and sometimes difficult handling operation and which in addition leads to the problem of the temporary stowage of the removed headrests.

Document FR-2471162 shows a seat layout in which, when the backrest is folded down, the upper zone or upper zones of the backrest fit into one or more corresponding cavities provided in the lower face of the seat pan. A similar layout is shown in documents DE-3325927 and U.S. Pat. No. 6,371,559, where, in addition, the headrest pivots towards the rear of the backrest when the backrest is folded forwards to facilitate the fitting of the headrest into the corresponding cavity of the seat pan. The disadvantage of these systems is that the cavity or cavities made in the bottom of the seat pan reduce the thickness of the seat pan which may be detrimental to the comfort of the user.

### SUMMARY OF THE INVENTION

The object of the present invention is to solve these problems and in particular to facilitate the folding down of the backrest of the folding rear seats without the need to previously remove the headrests.

With these targets in mind, the object of the invention is an automobile vehicle rear seat layout including a seat pan hinged on the floor of the vehicle which can be raised and tilted forwards from a normal utilization position, a backrest hinged on the floor of the vehicle which can be folded down, when the seat pan is raised, to the location occupied by the seat pan when in normal utilization position, the backrest being equipped with a headrest, characterized in that, at least in the seat pan zone located opposite the headrest when the seat pan is raised and the backrest folded down, the seat pan includes a cavity defining a part of the seat pan where the thickness is reduced and, in the floor zone located opposite the cavity when the seat pan is in normal utilization position, an additional padding element is connected to the floor, the additional padding element having a shape in relief corresponding to the hollow shape of the cavity.

As the seat pan has a reduced thickness, obtained whilst conserving the shape of the upper surface of a seat of same type but produced according to prior art, it follows that, when the seat pan is tilted forwards, the cavity made in the lower face of the seat pan creates, at the rear of the seat pan thus raised, a larger free space and therefore leaves space free for the headrest of the rear backrest when the backrest is folded down. The additional padding element, attached to the floor and with a shape in relief complementary to the hollow shape of the cavity made in the lower face of the seat pan, compensates, when the seat pan is returned to its normal utilization position, for the reduction in thickness of the seat pan to conserve comfort equivalent to that of a seat with thicker padding of conventional type.

In other words, when the seat in accordance with the invention is used normally by a user, its comfort is more or less the same as that of a conventional seat the padding of which will have a thickness equal to the sum of the padding thicknesses related to the raisable part of the seat pan and the additional padding element. But, when the seat pan is raised, its overall size is greatly reduced and the backrest of the rear seat can be folded down by a maximum without the need to remove the headrest. Note, incidentally, that when the backrest is thus folded down, it can locally bear on the part of the additional padding element in relief without this comprising a hindrance, as the additional padding element is, like the padding of the seat, elastically compressible, and it can thus if needed be deformed to conform to the relief of the front face of the backrest which bears against it.

According to a specific arrangement of the invention, the reduced thickness part of the seat pan extends over the complete width of the seat pan except for the side edges and the additional padding element extends in a single piece over the complete width of the reduced thickness part. Although it is possible to reduce the thickness of the seat pan padding only in the zones where the headrests are liable to make contact, it is easier to reduce the thickness over a zone extending continuously over the width of the seat pan and, in addition, the making of the additional padding element in a single piece and its attachment to the floor of the vehicle are also facilitated.

Typically, the thickness of the raisable part of the seat pan can be between 20 and 30 mm and that of the additional padding element between 20 and 60 mm.

Preferably also, in a manner known, per se, the seat pan includes a metallic wire framework and synthetic foam padding. The additional padding element is also made of synthetic foam which can be of same type or of a different type, for example a polyurethane foam, and with characteristics also identical to those of the raisable part or not.

The object of the invention is also an automobile vehicle characterized in that it includes a rear seat layout as defined above and an additional padding element attached to the floor below the location of the seat pan of the rear seat in its normal utilization position.

Other features and advantages will become apparent in the description which will be given of a utilization example of the invention in a vehicle including a rear bench seat where the seat pan and the backrest are made in two parts, type commonly called a ⅓-⅔ bench seat.

### BRIEF DESCRIPTION OF THE DRAWINGS

FIG. 1 is a schematic sectional side view of the layout of the front and rear seats through a longitudinal plane passing more or less between the two parts of the rear seat, the rear seat being in normal utilization position,

FIG. 2 shows the rear seat when the seat pan has been moved slightly to disengage the rear of the seat pan from the lower edge of the backrest and thus allow the seat pan to be tilted forwards,

FIG. 3 shows the seat pan of the rear seat in an intermediary tilted position,

FIG. 4 shows the layout of the seats when the seat pan of the rear seat is completely tilted forwards to against the backrest of the front seat,

FIG. 5 shows the layout of the seats when the backrest of the rear seat is folded down, the headrest in contact with the lower face of the raised seat pan,

FIG. 6 is a schematic sectional view through line A-A of FIG. 1,

FIG. 7 is a schematic sectional view through line B-B of FIG. 6, and

FIG. 8 is a schematic sectional view through line C-C of FIG. 5.

### DETAILED DESCRIPTION OF PREFERRED EMBODIMENTS

Preferred embodiments of the present invention will be described in detail hereinbelow with reference to the attached drawings.

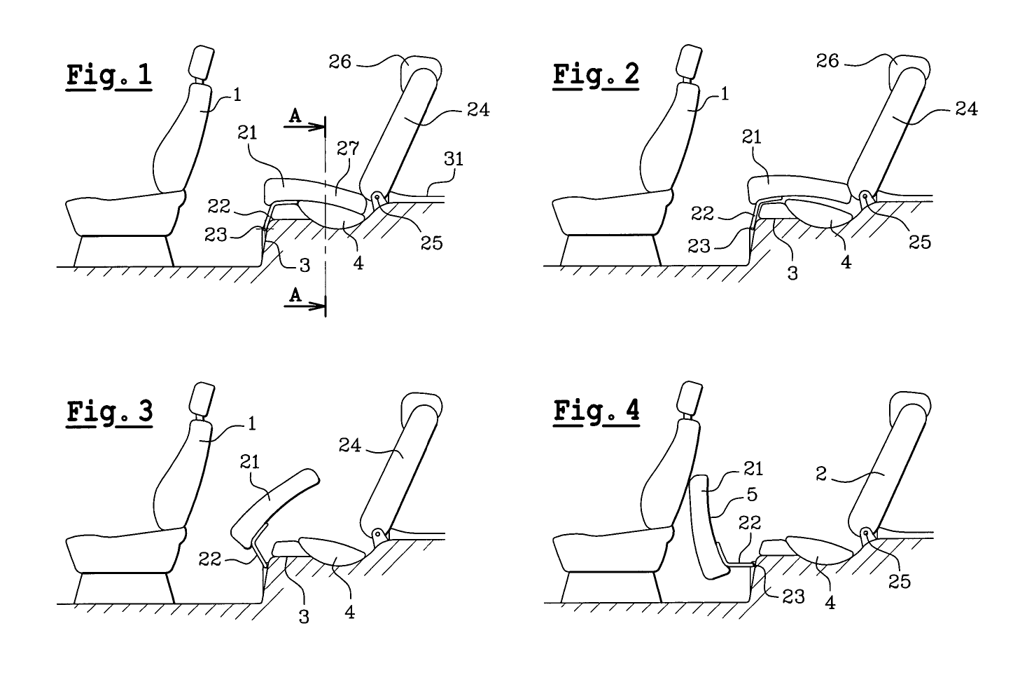

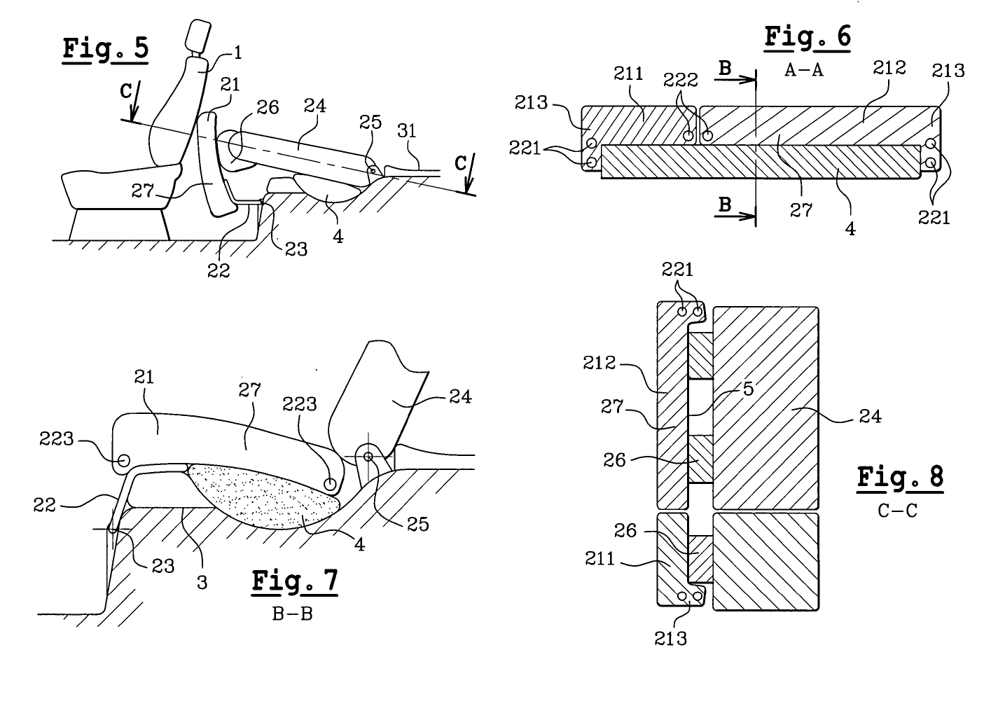

The drawing of FIG. 1 schematically shows a front seat 1, and a rear seat 2, which is typically a two-part bench seat, called a ⅓-⅔ type, which includes a seat pan 21 the framework 22 of which is installed so as to pivot at its front edge on the floor 3 of the vehicle, by a pivot 23, and a backrest 24 the lower edge of which is also connected to the floor 3 by a pivot 25 and which accommodates a headrest 26.

The seat pan 21 of the seat includes a padding element 27, made for example of polyurethane foam, molded onto the framework 22 made, in a manner itself known, from metallic wires 221, 222 and 223 a cross sectional view of which is shown on FIGS. 6 to 8, the whole being covered conventionally by a fabric cover or similar. The padding can also, conventionally, be simply placed on the framework and held in place by the cover.

The padding 27 is thin, for example around 20 to 30 mm, over the major part of the total length of the rear bench seat as is clearly shown on FIG. 6. This thin zone 5 extends between the side edges 213 of the two parts 211, 212 respectively of the seat pan. These side edges 213 are thicker, for example 40 to 90 mm, susceptible to accommodate two superimposed framework wires 221.

An additional padding element 4, consisting of a piece of polyurethane foam and shaped to mate, on the one hand, with the shape of the floor surface under the seat pan of the rear bench seat and, on the other hand, with the shape of the surface below the seat pan, is placed on the floor of the vehicle and extends, preferably continuously, between the two side edges 213 of the two seat pan parts. The thickness of this element is typically 40 to 60 mm in its thickest section. The additional padding element 4 is attached to the floor 3, for example by plastic attaching parts, of a type used currently in the automobile field, by pieces of hook and loop fastener fabric of VELCRO® type, by bonding or any other attachment or connection means suitable to keep it in place. The additional padding element 4 can be covered by an unwoven fabric to protect it this being however not necessary as it is always normally covered either by the seat pan or by the folded down backrest.

To increase the load-carrying volume in the boot of the vehicle, from the normal utilization position of the rear seat, shown on FIG. 1, the rear of the seat pan below the lower edge of the backrest is first disengaged as shown on FIG. 2, which is facilitated by a flexibility of the seat pan framework. Then, the seat pan is tilted forwards around its pivot 22, as shown on FIG. 3, to place it against the backrest of the front seats 1 as shown on FIG. 4.

Thanks to the clearance obtained at the rear of the seat pan, in raised position, in the reduced thickness zone 5, that is clearly shown on FIG. 8, the two parts of the backrest 24 can then be folded down without the need to remove the headrests as these can pass in the cleared space to take up a position more or less against the lower face of the seat pan. The two parts of the backrest 24 thus folded down then cover the additional padding element 4 without this element hindering the folding down of the backrest to a position where the rear face of the backrest is more or less aligned with the boot floor surface 31. It is also possible of course, in a normal manner, to tilt the seat pan and fold down the backrest of only one of the two parts of the bench seat.

The invention is not limited to the embodiment described above only as an example. In particular, the shapes of the additional padding element can be modified to adapt them to the shapes of the floor and the seat. The structure of the seat pan can also be of a type different from that with a wire framework.

What is claimed is:

1. An automobile vehicle rear seat including:
a seat pan hinged on a floor of a vehicle and which can be raised and tilted forwards from a normal utilization position; and
a backrest hinged on the floor of the vehicle and foldable, when the seat pan is raised, onto the location occupied by the seat pan in its normal utilization position, the backrest being equipped with a headrest,
wherein, at least in a zone of the seat pan located opposite the headrest when the seat pan is raised and the backrest folded down, the seat pan includes a cavity defining a part of the seat pan where the thickness is reduced, and
in a zone of the floor located opposite the cavity when the seat pan is in its normal utilization position, an additional padding element is attached to the floor, the additional padding element having a shape in relief corresponding to the hollow shape of the cavity.

2. The rear seat in accordance with claim 1, wherein the thickness of the seat pan in the part where the thickness is reduced is between 20 and 30 mm.

3. The rear seat in accordance with claim 1, wherein the additional padding element has a thickness of 20 to 60 mm.

4. The rear seat in accordance with claim 1, wherein the seat pan includes a framework made of metallic wires and synthetic foam padding.

5. The rear seat in accordance with claim 1, wherein the additional padding element is made of synthetic foam.

6. The rear seat in accordance with claim 1, wherein the part of the seat pan where the thickness is reduced extends over the complete width of the seat pan except for the side edges and the additional padding element extends in one piece over the complete width of the part where the thickness is reduced.

7. The rear seat in accordance with claim 6, wherein the seat pan is in two parts.

8. An automobile vehicle comprising:
a rear seat including:
a seat pan hinged on a floor of the vehicle and which can be raised and tilted forwards from a normal utilization position; and
a backrest hinged on the floor of the vehicle and foldable, when the seat pan is raised, onto the location occupied by the seat pan in its normal utilization position, the backrest being equipped with a headrest,
wherein, at least in a zone of the seat pan located opposite the headrest when the seat pan is raised and the backrest folded down, the seat pan includes a cavity defining a part of the seat pan where the thickness is reduced; and
an additional padding element made of synthetic foam and attached to the floor below the location of the seat pan in its normal utilization position, the additional padding element having a shape in relief corresponding to the hollow shape of the cavity.

9. The automobile vehicle in accordance with claim 8, wherein the thickness of the seat pan in the part where the thickness is reduced is between 20 and 30 mm.

10. The automobile vehicle in accordance with claim 8, wherein the additional padding element has a thickness of 20 to 60 mm.

11. The automobile vehicle in accordance with claim 8, wherein the seat pan includes a framework made of metallic wires and synthetic foam padding.

12. The automobile vehicle in accordance with claim 8, wherein the part of the seat pan where the thickness is reduced extends over the complete width of the seat pan except for the side edges and the additional padding element extends in one piece over the complete width of the part where the thickness is reduced.

13. The automobile vehicle in accordance with claim 12, wherein the seat pan is in two parts.
